(19) United States
(12) Patent Application Publication
(10) Pub. No.: US 2026/0247376 A1
(43) Pub. Date: Aug. 20, 2026

(54) METHODS AND STRUCTURES FOR DOWNLINK CONTROL CHANNELS

(71) Applicant: InterDigital Patent Holdings, Inc., Wilmington, DE (US)

(72) Inventors: Moon IL Lee, Melville, NY (US); Paul Marinier, Brossard (CA); Tao Deng, New York, NY (US); Aata El Hamss, Laval (CA); Ghyslain Pelletier, Montreal (CA)

(73) Assignee: InterDigital Patent Holdings, Inc., Wilmington, DE (US)

(21) Appl. No.: 19/054,195

(22) Filed: Feb. 14, 2025

(51) Int. Cl. H04W 72/1273; H04L 1/1867

(52) U.S. Cl. CPC H04W 72/1273; H04L 1/1896

(57) ABSTRACT

Methods, apparatuses, and systems are disclosed. In one example, a method performed by a wireless transmit/receive unit (WTRU) includes receiving first downlink control information in an OOB-CC, wherein the first downlink control information comprises configuration information associated with a plurality of physical downlink shared channel candidates of a scheduling region, wherein the scheduling region is associated with data transmissions; decoding one or more IB-CCEs associated with a subset of the plurality of physical downlink shared channel candidates to receive second downlink control information associated with the WTRU, wherein the second downlink control information indicates a scheduled data transmission for the WTRU in the subset of the plurality of physical downlink shared channel candidates; and demodulating the scheduled data transmission in the subset of the plurality of physical downlink shared channel candidates using scheduling parameters indicated by the second downlink control information provided by the one or more IB-CCEs.

### BACKGROUND

In a cellular network, downlink control channels may be used to transmit control information from a base station to a wireless transmit/receive unit (WTRU). The control information that a downlink control channel transmits may include many different types of information, such as scheduling assignments, resource allocations, Hybrid Automatic Repeat Request (HARQ) feedback (e.g., acknowledgments (ACKs) or negative acknowledgments (NACKs)), power-control commands, random-access signals, and/or paging signals, among other possibilities. Some examples of downlink control channels used in various types of cellular networks include a Physical Downlink Control Channel (PDCCH), an Enhanced PDCCH (EPDCCH), a Physical Control Format Indicator Channel (PCFICH), and/or a Physical HARQ Indicator Channel (PHICH), among other possible types of downlink control channels.

### SUMMARY

Methods and apparatuses for operation by a wireless transmit/receive unit (WTRU) in a network are provided.

In one example, a method performed by a WTRU may include receiving first downlink control information in an out-of-band control channel (OOB-CC), wherein the first downlink control information comprises configuration information associated with a plurality of physical downlink shared channel candidates of a scheduling region, wherein the scheduling region is associated with data transmissions; decoding (e.g., blindly decoding) one or more in-band control channel elements (IB-CCEs) associated with a subset of the plurality of physical downlink shared channel candidates (e.g., to determine that second downlink control information associated with the WTRU is located within the one or more IB-CCEs) to receive second downlink control information associated with the WTRU, wherein the second downlink control information indicates a scheduled data transmission for the WTRU in the subset of the plurality of physical downlink shared channel candidates; and demodulating the scheduled data transmission in the subset of the plurality of physical downlink shared channel candidates using scheduling parameters indicated by the second downlink control information provided by the one or more IB-CCEs.

The configuration information of the first downlink control information may comprise an indication of a size of the subset of the plurality of physical downlink shared channel candidates, an indication of a size of the one or more IB-CCEs, an aggregation level associated with the one or more IB-CCEs, or an indication of an association between reference signal ports and the one or more IB-CCEs.

The second downlink control information may comprise an indication of the scheduling parameters for demodulating the scheduled data transmission. The scheduling parameters may comprise a modulation and coding scheme (MCS), a transmission rank, a transmission configuration indication (TCI) state, a reference signal configuration, or a hybrid automatic repeat request (HARQ) process number associated with the scheduled transmission.

The first downlink control information may be received outside of the scheduling region (e.g., time and frequency resources) associated with the data transmissions. The second downlink control information may be received within the scheduling region associated with the data transmissions. The data transmissions may be scheduled via one or more data scheduling units.

The method may further comprise determining the subset of the plurality of physical downlink shared channel candidates based on one or more of a capability of the WTRU (e.g., a bandwidth capability such as wideband or narrowband), an identity of the WTRU (e.g., a C-RNTI), or an indication provided via the first downlink control information of the OOB-CC.

The scheduling region may comprise a plurality of data channel units and a plurality of data scheduling units. Each data scheduling unit may comprise one or more data channel units. A data channel unit may be a minimum schedule resource for a data transmission.

The method may further comprise decoding at least one IB-CCE associated with each physical downlink shared channel candidate of the plurality of physical downlink shared channel candidates to identify the second downlink control information associated with the WTRU.

A physical downlink shared channel candidate of the subset of the plurality of physical downlink shared channel candidates may comprise a plurality of IB-CCEs.

A subset of the plurality of IB-CCEs may comprise the second downlink control information associated with the WTRU. A remainder of the plurality of IB-CCEs may be reallocated for the scheduled data transmission.

The one or more IB-CCEs may be located within the subset of the plurality of physical downlink shared channel candidates. The subset of the plurality of physical downlink shared channel candidates may be assigned to the WTRU.

A remainder of the plurality of physical downlink shared channel candidates may be associated with one or more other WTRUs. The remainder of the plurality of physical downlink shared channel candidates may be a set of physical downlink shared channel candidates that (i) are included in the plurality of physical downlink shared channel candidates, but (ii) are not included in the subset of the plurality of physical downlink shared channel candidates.

The first downlink control information may be characterized by a longer duty cycle than the second downlink control information.

The first downlink control information may indicate that the one or more IB-CCEs comprise downlink control information (e.g., and therefore have not been repurposed to carry some other type of information other than downlink control information).

Each physical downlink shared channel candidate of the plurality of physical downlink shared channel candidates may comprise one or more data channel units. A data channel unit may be a minimum schedule resource for a data transmission.

Each physical downlink shared channel candidate of the subset of the plurality of physical downlink shared channel candidates may be associated with an aggregation level associated with a data scheduling unit.

In another example, a wireless transmit/receive unit (WTRU) may comprise a processor configured to: receive first downlink control information in an out-of-band control channel (OOB-CC), wherein the first downlink control information comprises configuration information associated with a plurality of physical downlink shared channel candidates of a scheduling region, wherein the scheduling region is associated with data transmissions; decode (e.g., blindly decode) one or more in-band control channel elements (IB-CCEs) associated with a subset of the plurality of physical downlink shared channel candidates (e.g., to determine that second downlink control information associated with the WTRU is located within the one or more IB-CCEs) to receive second downlink control information associated with the WTRU, wherein the second downlink control information indicates a scheduled data transmission for the WTRU in the subset of the plurality of physical downlink shared channel candidates; and demodulate the scheduled data transmission in the subset of the plurality of physical downlink shared channel candidates using scheduling parameters indicated by the second downlink control information provided by the one or more IB-CCEs.

The configuration information of the first downlink control information may comprise an indication of a size of the subset of the plurality of physical downlink shared channel candidates, an indication of a size of the one or more IB-CCEs, an aggregation level associated with the one or more IB-CCEs, or an indication of an association between reference signal ports and the one or more IB-CCEs.

The second downlink control information may comprise an indication of the scheduling parameters for demodulating the scheduled data transmission. The scheduling parameters may comprise a modulation and coding scheme (MCS), a transmission rank, a transmission configuration indication (TCI) state, a reference signal configuration, or a hybrid automatic repeat request (HARQ) process number associated with the scheduled transmission.

The first downlink control information may be received outside of the scheduling region (e.g., time and frequency resources) associated with the data transmissions. The second downlink control information may be received within the scheduling region associated with the data transmissions. The data transmissions may be scheduled via one or more data scheduling units.

The processor may be further configured to determine the subset of the plurality of physical downlink shared channel candidates based on one or more of a capability of the WTRU (e.g., a bandwidth capability such as wideband or narrowband), an identity of the WTRU (e.g., a C-RNTI), or an indication provided via the first downlink control information of the OOB-CC.

The scheduling region may comprise a plurality of data channel units and a plurality of data scheduling units. Each data scheduling unit may comprise one or more data channel units. A data channel unit may be a minimum schedule resource for a data transmission.

The processor may be further configured to decode at least one IB-CCE associated with each physical downlink shared channel candidate of the plurality of physical downlink shared channel candidates to identify the second downlink control information associated with the WTRU.

A physical downlink shared channel candidate of the subset of the plurality of physical downlink shared channel candidates may comprise a plurality of IB-CCEs.

A subset of the plurality of IB-CCEs may comprise the second downlink control information associated with the WTRU. A remainder of the plurality of IB-CCEs may be reallocated for the scheduled data transmission.

The one or more IB-CCEs may be located within the subset of the plurality of physical downlink shared channel candidates. The subset of the plurality of physical downlink shared channel candidates may be assigned to the WTRU.

A remainder of the plurality of physical downlink shared channel candidates may be associated with one or more other WTRUs. The remainder of the plurality of physical downlink shared channel candidates may be a set of physical downlink shared channel candidates that (i) are included in the plurality of physical downlink shared channel candidates, but (ii) are not included in the subset of the plurality of physical downlink shared channel candidates.

The first downlink control information may be characterized by a longer duty cycle than the second downlink control information.

The first downlink control information may indicate that the one or more IB-CCEs comprise downlink control information (e.g., and therefore have not been repurposed to carry some other type of information other than downlink control information).

Each physical downlink shared channel candidate of the plurality of physical downlink shared channel candidates may comprise one or more data channel units. A data channel unit may be a minimum schedule resource for a data transmission.

Each physical downlink shared channel candidate of the subset of the plurality of physical downlink shared channel candidates may be associated with an aggregation level associated with a data scheduling unit.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of a time/frequency resource grid within a TTI and a frequency resource used and/or determined for the TTI.

FIG. 3 shows an example of a time/frequency resource grid that depicts IB-CCE aggregation levels within a scheduled PDSCH (e.g., a set of DSUs).

FIG. 4 shows an example of a time/frequency resource grid that depicts a DM-RS port association between an IB-CCE and an associated PDSCH.

FIG. 5 shows an example of a time/frequency resource grid that depicts a PDSCH candidates in a TTI.

### DETAILED DESCRIPTION

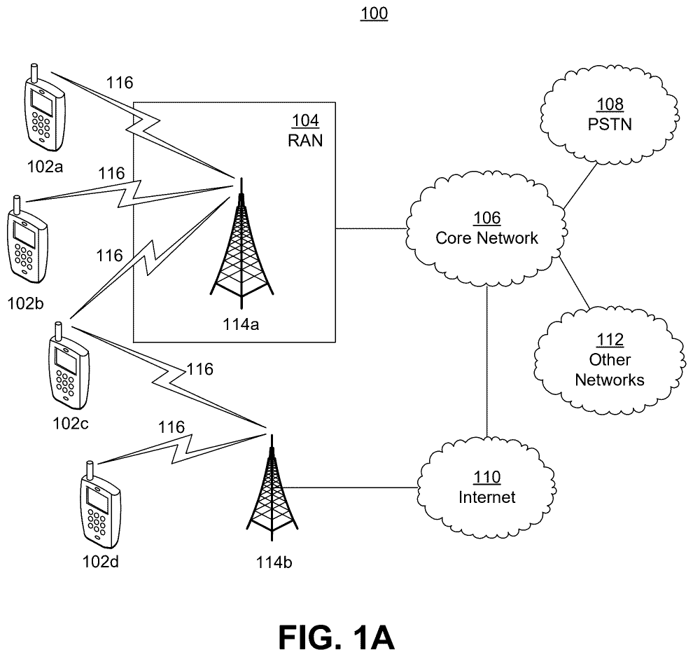

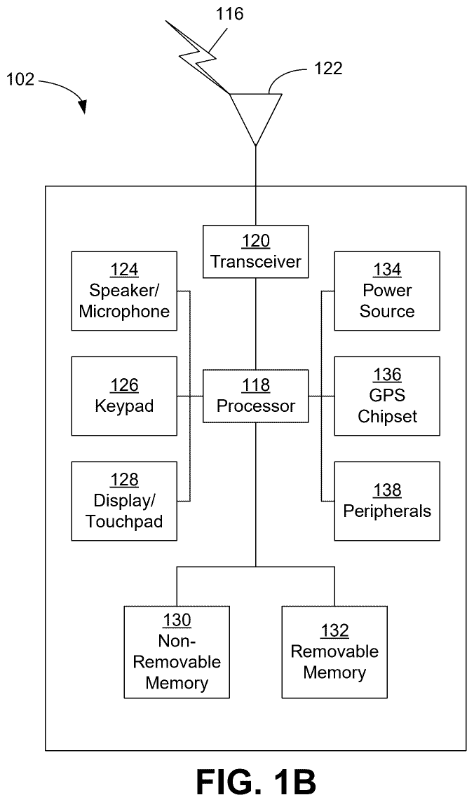

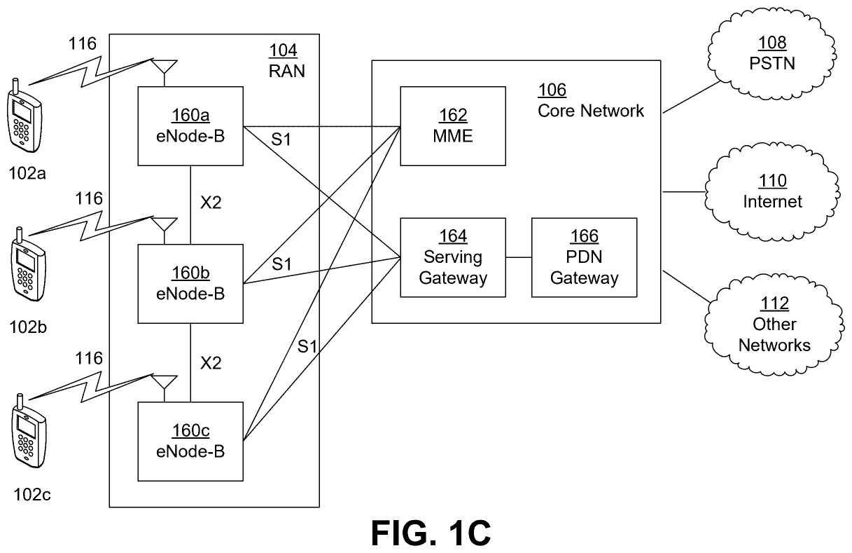

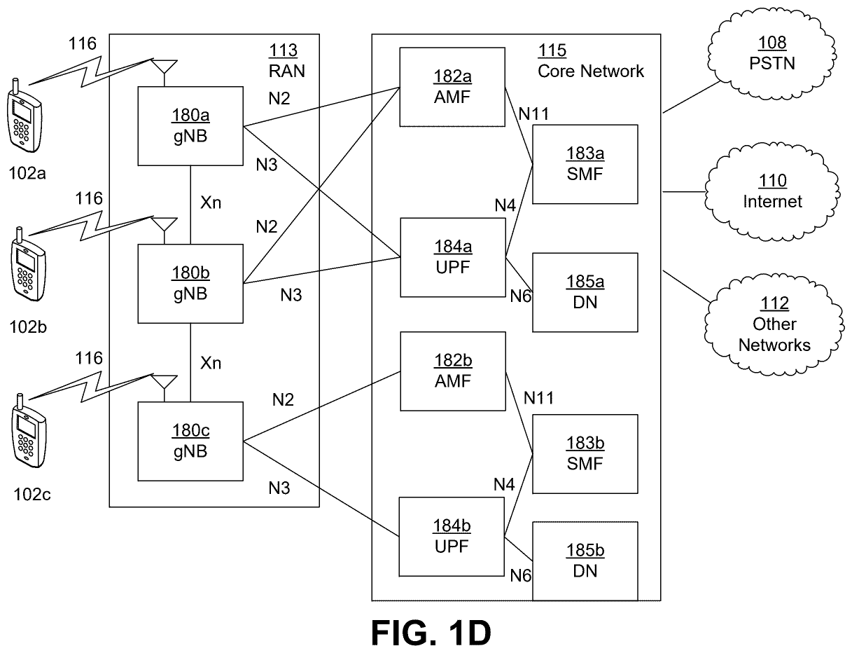

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102 c, 102 d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In cellular networks (e.g., 6G networks), it is desirable that a downlink control channel should support various types of WTRUs (e.g., WTRUs having different capabilities in terms of frequency and/or bandwidth) and/or different coverage levels. It is also desirable to have a common design for a downlink control channel that is used to support different types of devices (e.g., smart phones, IoT devices for LPWA use cases, devices for ultra-reliable low-latency service, etc.).

Downlink control channels have been designed and used in 4G and 5G. In the previous generations, downlink control channels have been designed for specific device types and/or specific device capabilities. As a result, in previous generations, a given control channel may not be applicable for some device types. Furthermore, in some cases (e.g., in 4G and 5G), multiple DL control channels should be used at the same time to support various types of WTRUs and/or coverage levels.

Using multiple DL control channels in a carrier increases complexity at the transmitter and may waste resources (e.g., radio resources) because each DL control channel should be configured in non-overlapping resources. Existing technologies do not provide a way to obviate this increased complexity and this waste of resources.

The present disclosure describes technological solutions for addressing the problems described above. In some examples, one or more downlink shared-channel candidates (e.g., Physical Downlink Shared Channel (PDSCH) resources) may be configured and used. Each downlink shared-channel candidate may have an In-Band Control Channel (IB-CC) within the resources for the downlink shared-channel candidate. A WTRU may monitor a subset of downlink shared-channel candidates (e.g., by attempting to decode an IB-CC associated with each shared-channel candidate, respectively). When the WTRU receives Downlink Control Information (DCI) that targets (e.g., is intended for and/or directed to) the WTRU in a given IB-CC, the WTRU may determine that the downlink shared-channel candidate associated with the given IB-CC is scheduled for the WTRU.

In some examples, the set of downlink shared-channel candidates may be configured or indicated by an associated Out-of-Band Control Channel (OOB-CC). The OOB-CC associated with the set of downlink shared-channel candidates may be monitored by a group of WTRUs.

In some examples, the subset of downlink shared-channel candidates that a WTRU may monitor may be determined based on one or more of: one or more WTRU capabilities (e.g., bandwidth) of the WTRU, a WTRU identity (e.g., as indicated by a Cell Radio Network Temporary Identifier (C-RNTI) or some other type of identifier) of the WTRU, and/or an indication provided via the associated OOB-CC (i.e., the OOB-CC that is associated with the set of downlink shared-channel candidates).

The WTRU may monitor an OOB-CC (e.g., specified in the configured resources associated with the WTRU) with a periodicity (e.g., a periodicity that indicates a number of slots and/or a duration of slot changes within a subcarrier spacing (SCS)).

The WTRU may receive a first DCI in an OOB-CC. The first DCI may provide configurations for downlink shared-channel candidates (PDSCH candidate configurations) in one or more time resources (e.g., TTIs).

The WTRU may decode one or more IB-CC elements (IB-CCEs) in the downlink shared-channel candidates (e.g., PDSCH candidates) in the one or more time resources indicated by the first DCI (which, as noted above, may have been received in the OOB-CC).

The WTRU may receive, in an IB-CCE of the one or more IB-CCEs, a second DCI that targets the WTRU. The first DCI may be characterized by a longer duty cycle than the second DCI. In response to and/or upon receiving the second DCI, the WTRU may demodulate a downlink shared channel (e.g., PDSCH) that is associated with the IB-CCE. To demodulate the given downlink shared channel, the WTRU may use scheduling information received from the IB-CCE. The scheduling information received from the IB-CCE may comprise respective values (e.g., actual parameters and/or arguments) for one or more scheduling parameters (e.g., formal parameters) for the downlink shared channel. The scheduling parameters may comprise, for example, a Modulation and Coding Scheme (MCS) parameter, a Transport Block Size (TBS) parameter, and/or a Hybrid Automatic Repeat Request (HARQ) process-number parameter, among other possibilities.

The technological solutions described herein provide a number of benefits. For instance, in some examples, a control channel for scheduling information may be transmitted within a scheduled resource, thereby addressing control-channel capacity issues that may occur when a large number of WTRUs are active. In addition, in some examples, a common design of the control channel may be used for each type of device that may connect to a network. The technological solutions described herein may also provide other benefits. Several examples of technological solutions are provided below, although other examples are also possible.

In one example, two types of control channels (e.g., downlink control channels) may be used to deliver control information (e.g., downlink control information) to a WTRU. A first type of control channel may be a control channel which may be transmitted, monitored, and/or received within a scheduled resource (e.g., a PDSCH, a Physical Uplink Shared Channel (PUSCH), etc.).

A second type of control channel may be a control channel which may be transmitted, monitored, and/or received outside of a scheduled resource (e.g., within a resource that is not a scheduled resource).

The first type of control channel may be referred to as an In-Band Control Channel (IB-CC) and the second type of control channel may be referred to as an Out-of-Band Control Channel (OOB-CC).

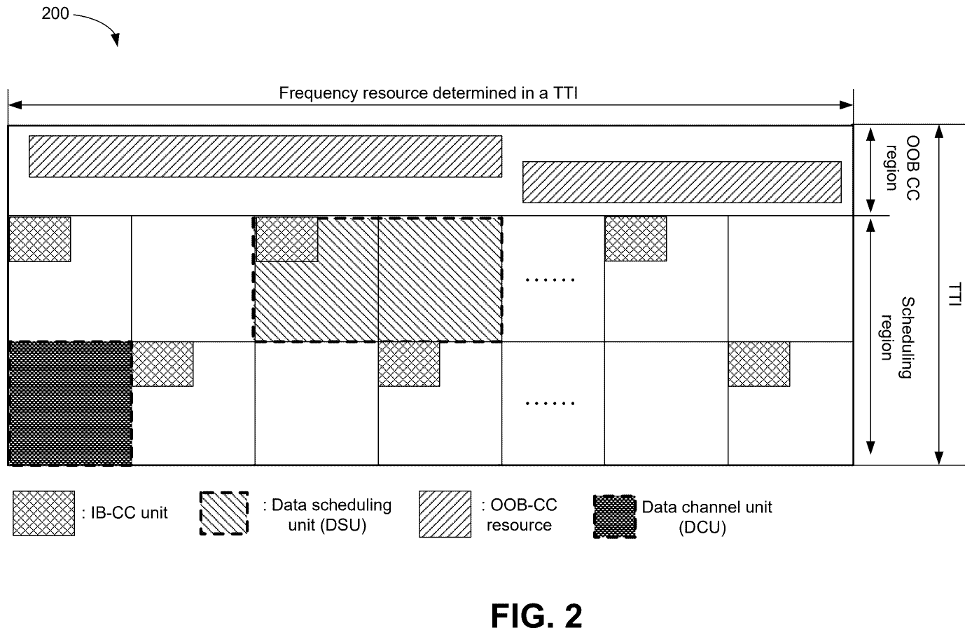

FIG. 2 shows an example of a time/frequency resource grid 200 within a TTI and a frequency resource used and/or determined for the TTI. Herein, the TTI may be a time unit wherein a WTRU may be scheduled for a channel for reception of data and/or a set of control channels associated with the WTRU. The frequency resource used and/or determined for the TTI may be referred to as a Bandwidth Part (BWP), sub-band, frequency band, carrier, and/or frequency resource. With regard to a frequency resource (e.g., the frequency resource used and/or determined for the TTI), one or more of following possible properties may apply.

As one property, a frequency resource may be changed in a TTI level or a set of TTI levels.

As another property, a transmission direction of one or more portions of a frequency resource in a TTI may be different and/or determined in a TTI level or a set of TTI levels. For example, a first portion of a frequency resource (e.g., N Physical Resource Blocks (PRBs) in the middle, where N denotes a non-negative integer) may be determined to have a first transmission direction (e.g., uplink) and a remainder portion of the frequency resource may be determined to have a second transmission direction (e.g., downlink). The downlink control resources (e.g., OOB-CC and/or IB-CC) within a downlink frequency resource (e.g., a frequency resource having a downlink direction) may be considered as active and/or valid control resources to be monitored by a WTRU.

As another property, an OOB-CC resource may be configured within an OOB-CC time/frequency resource region, wherein the OOB-CC time/frequency resource region within a TTI may be pre-configured and/or determined based on an OOB-CC resource configuration.

As another property, if an OOB-CC resource is configured in a first k Orthogonal Frequency Division Multiplexing (OFDM) symbols (e.g., where k denotes a non-negative integer), the OFDM symbols containing the OOB-CC resource may be determined to be in an OOB-CC region. A data channel (e.g., PDSCH resources containing the IB-CC) may start from the next symbol of the OOB-CC region (e.g., the first symbol of the data channel may be the symbol that follows immediately after the last symbol of the OOB-CC resource).

As another property, in a scheduling region (e.g., time/frequency resources not belonging to and/or located within the OOB-CC region in a TTI), a resource unit may be defined as and/or formed with a set of consecutive subcarriers and/or OFDM symbols. The resource unit may be referred to as a data channel unit (DCU) (e.g., and may, in some examples, be interchangeably referred to as a data channel element (DCE) or by some other name).

One or more DCUs may be formed and/or defined as a data scheduling unit (DSU). Each DSU may include at least one IB-CC unit. Within a DSU, an IB-CC unit may be defined, for example, as a DCU that includes scheduling information for the DSU.

Each IB-CC unit may be self-decodable. The scheduling information (e.g., included in at least one IB-CC unit) may comprise one or more of: an MCS level, a rank, a HARQ process number, a Transmission Configuration Indicator (TCI) state (e.g., comprising beam-related information), a number of DSUs used, a Demodulation Reference Signal (DMRS and/or DM-RS) configuration, a power allocation, and/or a repetition number.

One or more DSUs may be used and/or scheduled for data transmission.

One or more DCUs may be defined, determined, and/or used as a minimum schedule resource for a data channel (e.g., PDSCH, PUSCH, Physical Sidelink Shared Channel (PSSCH), etc.).

In some examples, an IB-CC unit may be interchangeably referred to as an IB-CC element (IB-CCE). An IB-CC unit may, for example, be a minimum control channel unit (or resource) that can be decoded by a WTRU.

In some examples, a control channel element for an OOB-CC may be referred to as an OOB-CC element (OOB-CCE). AN OOB-CCE may, for example, be a minimum control channel unit (or resource) that can be decoded by a WTRU. In some examples, an OOB-CCE may be interchangeably referred to as a CCE.

In some examples, a TTI may be interchangeably referred to as a subframe, a slot, a scheduling window, a transmission window, a reception window, a transmission periodicity, a reception periodicity, a scheduling time unit, and/or a scheduling time resource.

In some examples, an IB-CC may be interchangeably referred to as a local control channel, a second-stage control channel, a WTRU-dedicated control channel, a WTRU-specific control channel, and a device-type specific control channel. A WTRU may attempt to decode, monitor, and/or receive an IB-CC to determine whether a DSU that includes the IB-CC is scheduled for the WTRU or not. In some examples, a DSU may be interchangeably referred to as a DCU (e.g., in examples where one DCI is associated with a DSU).

An IB-CC unit may be defined, configured, or determined with a set of resource elements (REs) within an associated DSU (e.g., a DSU that includes an IB-CC that includes the IB-CC unit). The set of REs (e.g., a number of REs) and/or the location of the set of REs within the associated DSU may be determined based on one or more of the following approaches.

The set of REs and/or the location of the set of REs may be preconfigured and/or configured via a higher layer signaling (e.g., Radio Resource Control (RRC), MAC Control Element (CE), etc.).

In some examples, the WTRU may determine the set of REs and/or the location of the set of REs based on DSU type (e.g., a DSU type of the associated DSU). In one example, the DSU type may be determined as a function of one or more of the following characteristics.

The DSU type may be determined as a function of the size of the associated DSU. In one example, the size may be referred to as the number of REs associated with the associated DSU. In another example, the size of the associated DSU may be referred to as {n, m}, wherein n may a number of consecutive subcarriers associated with the associated DSU and m may be a number of consecutive OFDM symbols associated with the associated DSU.

The DSU type may be determined as a function of a number of available REs within the associated DSU. In one example, the number of available REs may be different based on how many REs within the associated DSU conflict with other, higher-priority signals and/or channels. Rate-matching around the conflicted REs may be performed and, in some examples, the conflicted REs may not be considered to be available REs.

The DSU type may be determined as a function of slot type (e.g., a slot type associated with the associated DSU). For instance, a DSU in a first slot type may be determined as a first DSU type and a DSU in a second slot type may be determined as a second DSU type, wherein a slot type may be based on a duplex type (e.g., DL-only slot, full-duplex slot, sub-band full-duplex slot, etc.).

The DSU type may also be determined as function of other characteristics.

For example, the WTRU may determine the set of REs and/or the location of the set of REs based on DSU index. In an example, one or more DSUs may be configured, defined, and/or used and each DSU may be associated with a respective index. The set of REs and/or the location of the set of REs within the associated DSU may be determined based on the respective DSU index associated with the associated DSU. The starting RE of an IB-CC unit may be determined based on the respective DSU index associated with the associated DSU. Therefore, an IB-CC resource may be randomized to mitigate interference (e.g., inter-cell interference).

The WTRU may determine the set of REs and/or the location of the set of REs based on a configuration indication from an associated control channel. In an example, an IB-CC may be used as a second-stage control channel to receive a PDSCH. Furthermore, in this example, a first-stage control channel (e.g., an OOB-CC) may be used to indicate how to receive and/or monitor the second-stage control channel (e.g., IB-CC). In this case, the first-stage control channel may indicate the configuration information (e.g., number of REs and the location of the set of REs within the associated DSU) for an IB-CC unit of the second-stage control channel.

The WTRU may determine the set of REs and/or the location of the set of REs based on a determined coverage level. For example, a WTRU may indicate and/or report a coverage level associated with the WTRU (e.g., based on measurement of a downlink signal and/or channel, etc.) and the coverage level may be confirmed by the network (e.g., to which the WTRU is connected). The coverage level may comprise and/or be based on one or more of the following factors.

For example, the coverage level may be based on a set of repetition numbers for a data channel and/or or a control channel that the WTRU may monitor and/or receive.

For example, the coverage level may be based on a range of received-signal strength based on a measurement. For example, if a received-signal strength is measured to be within a first range, the received-signal strength may be determined to be at a first coverage level. Similarly, if the received-signal strength is within a second range, the received-signal strength may be determined to be at a second coverage level, and so forth (e.g., for a third coverage level, a fourth coverage level, etc.). The received-signal strength may comprise and/or be based on at least one of Reference Signal Received Power (RSRP), Reference Signal Received Quality (RSRQ), Received Signal Strength Indicator (RSSI), Signal-to-Interference-plus-Noise Ratio (SINR), and/or pathloss (i.e., path attenuation).

The coverage level may also comprise and/or be based on other factors.

The WTRU may determine the set of REs and/or the location of the set of REs based on one or more WTRU-sided conditions. In some examples, a WTRU-sided condition may be referred to interchangeably as a WTRU capability, a WTRU category, a WTRU condition, and/or a WTRU type. In one example, a WTRU-sided condition may comprise and/or be based on one or more of the following possible factors.

The WTRU-sided condition may comprise WTRU capabilities (e.g., number of Tx/Rx antennas, supporting frequency bandwidth for downlink and/or uplink, device type, WTRU categories, support of low power receiver, maximum transmission power, supporting feature group, supporting functionalities, etc.).

The WTRU-sided condition may comprise a WTRU device status (e.g., remaining battery level, device temperature, etc.).

The WTRU-sided condition may comprise a WTRU's geographical-location-related information (e.g., zone-ID, cell-ID, Transmission Reception Point (TRP) ID (TRP-ID), anchor WTRU identity, etc.). The WTRU's geographical-location-related information may be acquired by the WTRU based on, for example, (i) the WTRU's positioning information and defined zone, (ii) a cell and/or TRP the WTRU is currently camped on and/or was previously camped on, and/or (iii) an anchor WTRU with which the WTRU is currently communicating and/or previously communicated.

The WTRU-sided condition may comprise a target operator identity (e.g., a Public Land Mobile Network ID (PLMN-id)).

The WTRU-sided condition may comprise a target use case (e.g., eMBB, URLLC, IoT, Industrial Internet of Things (IIoT), etc.).

The WTRU-sided condition may comprise WTRU channel conditions (e.g., RSRP level, SINR level, frequency selectivity level, Line of Sight (LoS) probability, indoor/outdoor, cell center and/or cell edge, etc.).

The WTRU-sided condition may comprise WTRU mobility conditions (e.g., WTRU speed, WTRU's moving direction, WTRU's handover frequency, etc.).

The WTRU-sided condition may comprise a WTRU network connection status (e.g., RRC connected, RRC idle, RRC inactive, etc.).

The WTRU-sided condition may comprise a coverage level determined for a WTRU (e.g., WTRU coverage level).

A WTRU-sided condition may also comprise and/or be based on other factors.

The WTRU may determine the set of REs and/or the location of the set of REs based on one or more Network (NW)-sided conditions. In some examples, an NW-sided condition may be referred to interchangeably as an NW-side configuration, an NW-side information, an NW condition, and/or an NW type. In an example, an NW-sided condition may comprise and/or be based on one or more of the following possible factors:

The NW-sided condition may comprise network-operator-related information (e.g., PLMN identity).

The NW-sided condition may comprise cell-related information (e.g., physical cell identity, global cell identity, etc.).

The NW-sided condition may comprise cell-barring-related information (e.g., supported WTRU types, WTRU categories, WTRU types and/or categories and/or WTRU capabilities not allowed for camping on the cell)

The NW-sided condition may comprise NW-capability-related information. NW-capability-related information may comprise one or more of: (i) support and/or activation of a WTRU power saving mode (e.g., wake up signal, Physical Downlink Control Channel (PDCCH) skipping, UL skipping, etc.), (ii) support of low-layer triggered mobility (LTM), and/or (iii) support of a specific service (e.g., broadcasting, positioning, sensing, artificial intelligence and/or machine learning (AI/ML), etc.), among other possible types of NW-capability-related information.

The NW-sided condition may comprise RAT-related information. RAT-related information may comprise one or more of: (i) support and/or deployment of a generation (4G, 5G, 6G, etc.) and/or (ii) support of multi-RAT spectrum sharing (MRSS) with one or more generation (e.g., 4G, 5G, 6G, etc.), among other possible types of RAT-related information.

The NW-sided condition may comprise transmitter (e.g., next generation Node B (gNB), TRP, satellite, anchor WTRU, etc.) geographical information (e.g., country, zone, etc.).

The NW-sided condition may comprise NW type (e.g., terrestrial network or non-terrestrial network).

The NW-sided condition may comprise NW radio capability (e.g., number of antennas, active number of antennas, transmission power, number of beams, beam width, beam footprint, latency, etc.).

The NW-sided condition may comprise NW mode of operation (e.g., network energy saving mode, normal energy mode, etc.).

The NW-sided condition may comprise NW energy-saving status (e.g., on/off Cell-DTX/DRX, where DTX stands for Discontinuous Transmission and DRX stands for Discontinuous Reception; cell-DTX/DRX configuration; etc.).

The NW-sided condition may comprise NW-traffic-load status (e.g., high, medium, low).

The NW-sided condition may comprise broadcasting-channel transmission type (e.g., on-demand Single Sideband (SSB), on-demand System Information Block One (SIB1), on-demand System Information Block x (SIBx) (e.g., x denotes an integer greater than one), always-on SSB, always-on SIB1, etc.). When a WTRU identifies a broadcasting-channel transmission type, if the broadcasting-channel transmission type is based on on-demand, the WTRU may request in a pre-configured and/or configured uplink resource to request the signal or channel.

The NW-sided condition may comprise RAN sharing status (e.g., whether RAN sharing across multiple operators is used or not).

An NW-sided condition may also comprise and/or be based on other factors.

The WTRU may determine the set of REs and/or the location of the set of REs based on one or more frequency-spectrum-related conditions. In an example, a frequency-spectrum-related condition may comprise and/or be based on or more of following possible factors.

The frequency-spectrum-related condition may comprise an operating frequency band (e.g., which may indicate frequency bandwidth, frequency region, absolute frequency, etc.). An operating frequency band may be associated with an index (e.g., a frequency band number such as n1, n2, . . . , n94, etc.). Furthermore, an operating frequency band may represent a frequency spectrum with a starting frequency, an ending frequency, and/or a duplex mode (Time Division Duplexing (TDD), Frequency Division Duplexing (FDD), etc.).

The frequency-spectrum-related condition may comprise an operating bandwidth. For instance, an operating bandwidth may comprise a frequency resource (e.g., such as a default bandwidth part (BWP)) used, configured, and/or determined for a certain operation such as initial access, default operation, fallback operation, and/or common channel transmission (e.g., SSB, paging, SIB, PDCCH common search space, etc.).

The frequency-spectrum-related condition may comprise a channel bandwidth (e.g., actual channel bandwidth used by an operator within an operating frequency band).

The frequency-spectrum-related condition may comprise a frequency range (e.g., Frequency Range one (FR1), Frequency Range two (FR2), Frequency Range three (FR3), etc.).

The frequency-spectrum-related condition may comprise a carrier bandwidth (e.g., a target carrier bandwidth within a frequency band).

The frequency-spectrum-related condition may comprise sync raster number and/or identity. In one example, a sync raster number and/or identity may be determined based on a reference frequency of the sync raster. In one example, an identity may be global synchronization channel number (GSCN).

A frequency-spectrum-related condition may also comprise and/or be based on other factors.

The WTRU may determine the set of REs and/or the location of the set of REs based on one or more control channel elements (CCEs) and/or one or more resource element groups (REGs) that may be used to form an IB-CC unit. In this approach, the number of REs for an IB-CC unit may be determined based on an associated number of CCEs and/or REGs.

In some examples, the set of REs (e.g., a number of REs) and/or the location of the set of REs within the associated DSU may be determined based on a set of DSUs scheduled for a data transmission. For example, an IB-CC unit time/frequency location may be determined based on the set of DSUs scheduled for a WTRU, wherein the scheduling information of DSUs may be provided by an associated OOB-CC or higher layer configuration. One or more of following possible indications may apply:

As one possible indication, a WTRU may be indicated (e.g., configured with, for example, by the network) a number of DSUs used for data transmission (e.g., PDSCH). The WTRU may determine the resource of the IB-CC unit based on the indicated number of DSUs.

Based on the indicated number of DSUs, one or more PDSCH candidates may be determined within a TTI. The WTRU may blindly detect an IB-CC unit in each PDSCH candidate to check whether the associated PDSCH is scheduled for the WTRU or not.

As another possible indication, a WTRU may be indicated (e.g., configured with, for example, by the network) the number of DSUs and by which set of DSUs is scheduled for the WTRU. In this case, the WTRU may not have to detect PDSCH candidates blindly because the WTRU may be indicated by which PDSCH candidate is scheduled for the WTRU.

The WTRU may receive or attempt to decode an IB-CC unit within the scheduled PDSCH (e.g., the PDSCH candidate that is scheduled for the WTRU) to identify the rest of control information to demodulate the scheduled PDSCH.

One or more types of DM-RS may be used for an IB-CC unit. In particular, a first DM-RS type may be a DM-RS dedicated for the IB-CC unit and a second DM-RS type may be a DM-RS shared with other channels and/or signals. In this implementation, one or more of following approaches may apply.

In one possible approach, the DM-RS type for an IB-CC unit may be determined based on one or more of a WTRU-sided condition, a NW-sided condition, and/or frequency-spectrum-related conditions.

The DM-RS for an IB-CC unit may be shared and/or used for the associated DSU (e.g., PDSCH) when one or more of conditions are met. Some examples of such conditions may comprise (i) that the transmission rank of the PDSCH is the same as the transmission rank for the IB-CC unit (e.g., Rank=1), (ii) that the associated DSU be located in the same slot, (iii) that the network be configured such that DM-RS sharing is enabled, (iv) that an MCS for the associated DSU is below a threshold, and/or (iii) that the WTRU is a particular device type (e.g., low capability WTRU), among other possible examples of such conditions.

Control information in the IB-CC unit may indicate whether the DM-RS of the IB-CC unit can be used for the associated DSU. When the DM-RS of the IB-CC unit can be used for the associated DSU, it may may be said that the DM-RS of the IB-CC unit and DM-RS of the associated DSU experience the same channel and/or are quasi-collocated (e.g., such that high level channel properties such as delay spread, angular spread, Doppler spread, spatial Rx filter, and/or received power level are the same or similar for the DM-RS of the IB-CC unit and DM-RS of the associated DSU).

A DM-RS density of the associated DSU (e.g., PDSCH) may be determined based on whether the DM-RS for an IB-CC unit can be used for the associated DSU or not. For example, when a DM-RS for an IB-CC unit is shared and/or used for the associated DSU (e.g., PDSCH), a lower DM-RS density of the associated DSU may be used.

For a data transmission (e.g., PDSCH), when one or more DSUs are used (e.g., a PDSCH is scheduled with multiple DSUs), the DM-RSs in one or more IB-CC units within the scheduled DSUs may be bundled. For example, a first DM-RS of a first IB-CC unit and a second DM-RS of a second IB-CC unit may be bundled if the first IB-CC unit and the second IB-CC unit are within the scheduled data transmission. In one example, bundling may be referred to when the first DM-RS and the second DM-RS experience the same channels so that a WTRU can perform channel estimation for those same channels together (e.g., via interpolation, averaging, etc.).

A WTRU may determine to use a DM-RS of one or more IB-CC units in neighboring DSUs when the neighboring DSUs are used together for a data transmission and/or reception. The WTRU may be configured such that the configuration of the WTRU indicates which DSUs may be considered to be neighboring DSUs.

A WTRU may determine to use a DM-RS of the associated OOB-CC to demodulate IB-CC when one or more of following possible conditions are met.

The WTRU may determine to use a DM-RS of the associated OOB-CC to demodulate IB-CC when a DM-RS of the IB-CC is not present and/or not configured. For example, when a DM-RS is not configured for an IB-CC, a DM-RS of the associated OOB-CC (or DSU) may be used to demodulate the IB-CC.

The presence of a DM-RS may be indicated in various ways. In one example, the presence of the DM-RS may be indicated in an associated OOB-CC. In another example, the presence of the DM-RS may be configured via higher layer signaling. In another example, the presence of the DM-RS may be implicitly indicated and/or determined based on a DSU configuration (e.g., size of DSU). In another example, the presence of the DM-RS may be determined based on whether there is any conflict with a higher priority signal and/or channel.

The WTRU may determine to use a DM-RS of the associated OOB-CC to demodulate IB-CC when DM-RS overhead (e.g., density) for the IB-CC is less than a threshold. For example, when the DM-RS overhead (e.g., density) is below a threshold, a WTRU may use the DM-RS of the associated OOB-CC to improve the channel estimation performance.

The DM-RS of the associated OOB-CC may be interchangeably used with and/or referred to as the DM-RS of the associated DCU and/or the DM-RS of the associated DSU.

One or more IB-CCEs may be aggregated to achieve better performance. For example, a WTRU may be scheduled with a set of DSUs in a TTI. The WTRU may attempt to decode the set of IB-CCEs with different aggregation levels.

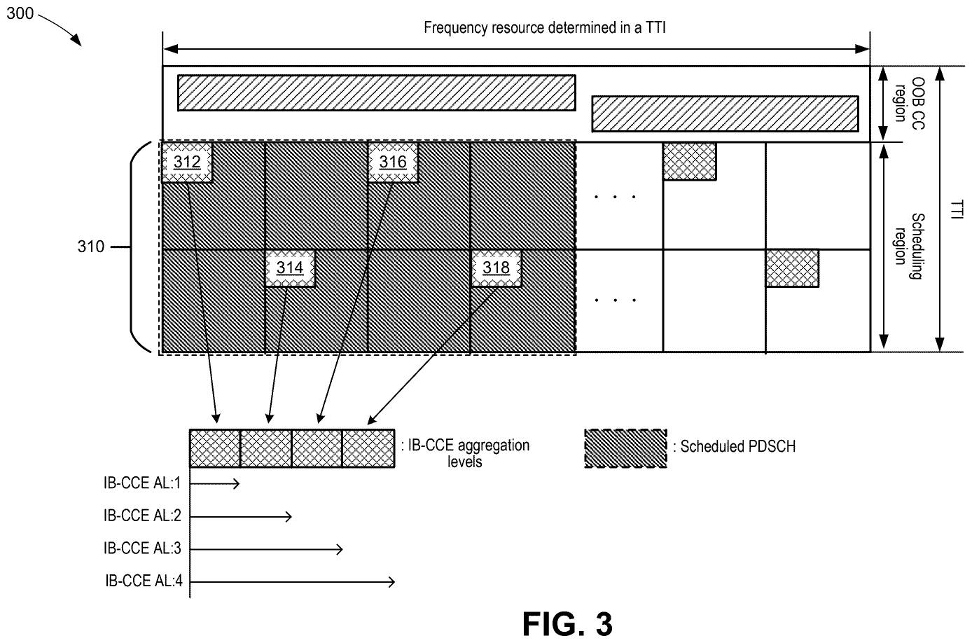

FIG. 3 shows an example of a time/frequency resource grid 300 that depicts IB-CCE aggregation levels 312, 314, 316, 318 within a scheduled PDSCH 310 (e.g., a set of DSUs).

IB-CCE aggregation may be performed by the WTRU based on an IB-CCE index order. In this approach, the IB-CCEs within the scheduled resources may be indexed based on a time-first mapping and/or a frequency-first mapping. Furthermore, in this approach, the respective indexes of the IB-CCEs may be pre-configured or pre-determined based on a DSU configuration and/or a DCU configuration.

IB-CCE aggregation may be performed by the WTRU based on a hashing function. The hashing function may determine a starting IB-CCE index (or number) as a function of at least one of: the associated time indices (e.g., slot number, subframe number, system frame number, OFDM symbol number, etc.), WTRU identity (e.g., C-RNTI, Temporary Mobile Subscriber Identity (TMSI), s-TMSI, Most Significant Bit (MSB) and/or Least Significant Bit (LSB) of International Mobile Subscriber Identity (IMSI), etc.), and/or WTRU group identity (e.g., a WTRU group identity number that is configured).

A maximum aggregation level may be determined based on the number of DSUs scheduled or used for a data transmission (e.g., a PDSCH transmission). For example, if four DSUs are used for a PDSCH transmission, the maximum IB-CCE aggregation level may be four.

The WTRU may be indicated or configured with a maximum aggregation level which may be smaller than the number of DSUs scheduled. For example, in a TTI, up to N1 DSUs may be scheduled for a WTRU for a PDSCH. In this example, the WTRU may be configured and/or may receive an indication that the maximum aggregation level is N2 (e.g., where N2<N1, and where N1 and N2 are non-negative integers).

An IB-CCE aggregation level set may be predefined and/or configured based on a range of the number of DSUs used for a PDSCH transmission. For example, a first IB-CCE aggregation level set {1, 2, 4, 8} may be used for a first range of scheduled DSUs (e.g., 1 to 8 DSUs), a second IB-CCE aggregation level set {1, 8, 16, 32} may be used for a second range of scheduled DSUs (e.g., 9 to 32 DSUs), and so on.

When a number of DSUs scheduled is smaller than an aggregation level within an IB-CCE aggregation level set, the WTRU may skip (e.g., refrain from) monitoring the aggregation level.

In addition or alternatively, the aggregation set {AL1, AL2, AL3, AL4} may be capped by the number of DSUs scheduled {min(AL1, N_DSU), min(AL2, N_DSU), min(AL3, N_DSU), min(AL4, N_DSU)}, wherein min (k1, k2) may be referred to as a MIN function which selects a minimum number from within two numbers and N_DSU may be the number of DSUs scheduled for a data transmission (e.g., PDSCH).

When more than one IB-CCE is used, a set of IB-CCEs may be repeated among the IB-CCEs used. For example, when AL=8 is used, the first two IB-CCEs may be repeated. If a WTRU successfully decodes a DCI carried by an IB-CC, the WTRU may stop receiving and/or demodulate the rest of the IB-CCEs even when AL=8 is used. In addition or alternatively, a DCI may be encoded and transmitted over each of the IB-CCEs within the aggregation level. Therefore, a WTRU may have to receive each of the IB-CCEs associated with the aggregation level.

One or more IB-CCEs that are not being used within the scheduled DSUs may be re-allocated for other purposes (e.g., PDSCH transmission, control channel scheduling in another transmission direction (e.g., UL or sidelink), measuring interference, and/or transmission in another other direction (e.g., UL or sidelink) from a WTRU). In this implementation, one or more of the following approaches may apply.

The WTRU may determine which IB-CCE is unused based on a successful reception of an associated DCI received from the one or more IB-CCEs within the scheduled resources. The associated DCI may indicate which IB-CCE is unused.

The WTRU may receive an indication from the associated OOB-CC of which IB-CCE is used for carrying a DCI. In some examples, a DCI carried by an IB-CC may be referred to as an IB-DCI and a DCI carried by an OOB-CC may be referred to as an OOB-DCI.

If an unused IB-CCE is used for interference measurement, an RE associated with the unused IB-CCE may be assumed to be zero-power transmission by a WTRU. In this approach, the WTRU may measure signal power in the RE to determine an interference level. In this case, rate-matching around the IB-CCE resources may be performed for a PDSCH transmission irrespective of whether an IB-CCE is used or unused.

If an unused IB-CCE is reallocated for a PDSCH transmission, the unused IB-CCE resource may be an available RE for determining a payload size of the PDSCH (e.g. TBS) with a determined MCS level. In this approach, the encoded symbols may be mapped to a non-IB-CCE resource first and the reallocated IB-CCE resource later to avoid ambiguity at the WTRU in an error case (e.g., misdetection of information for the unused IB-CCE).

One or more link-adaptation parameters (e.g., modulation order, coding rate, transmission rank, etc.) for an IB-CCE may be determined by the WTRU based on one or more of the following approaches.

One or more link-adaptation parameters may be fixed and/or pre-determined (e.g., Quadrature Phase Shift Keying (QPSK), transmission rank=1, etc.).

One or more link-adaptation parameters may be adaptively and/or dynamically determined based on a modulation order of the associated PDSCH (e.g., the same modulation order as the scheduled PDSCH).

One or more link-adaptation parameters may be determined based on an associated PDSCH type.

A PDSCH type may be, for instance, dynamic scheduling or semi-persistent scheduling (SPS). For example, pre-determined link-adaptation parameters (e.g., QPSK, rank-1) may be used for dynamic scheduling (e.g., where a WTRU blindly detects whether a DL resource is scheduled for the WTRU or not in the TTI). Adaptive link-adaptation parameters and/or indicated link-adaptation parameters (e.g., having a same modulation order and/or transmission rank as those of the associated PDSCH) may be used for the DL resources and may be semi-statically configured, or vice-versa.

The indication of one or more of link-adaptation parameters may be based on higher layer signaling (e.g., RRC, MAC-CE, etc.) and/or L1 signaling (e.g., a DCI which activates the SPS).

IB-CCE REs may be power-boosted over the associated PDSCH REs. In this implementation, the energy per RE (EPRE) ratio between IB-CCE REs and the associated PDSCH REs may be provided to a WTRU. The EPRE ratio may be indicated in a DCI carried in an IB-CCE.

A DM-RS port may be defined as a reference signal that may be associated with a transmission layer. The number of transmission layers for a transmission (e.g., PDSCH, PUSCH, PDCCH, etc.) may be one or more multiple, where the number of DM-RS ports associated with the transmission may be the same as the number of transmission layers. Herein, the number of transmission layers may be referred to as the transmission rank (or Rank). For example, Rank=K may indicate that the number of transmission layers associated with a transmission is K (e.g., where K denotes a non-negative integer).

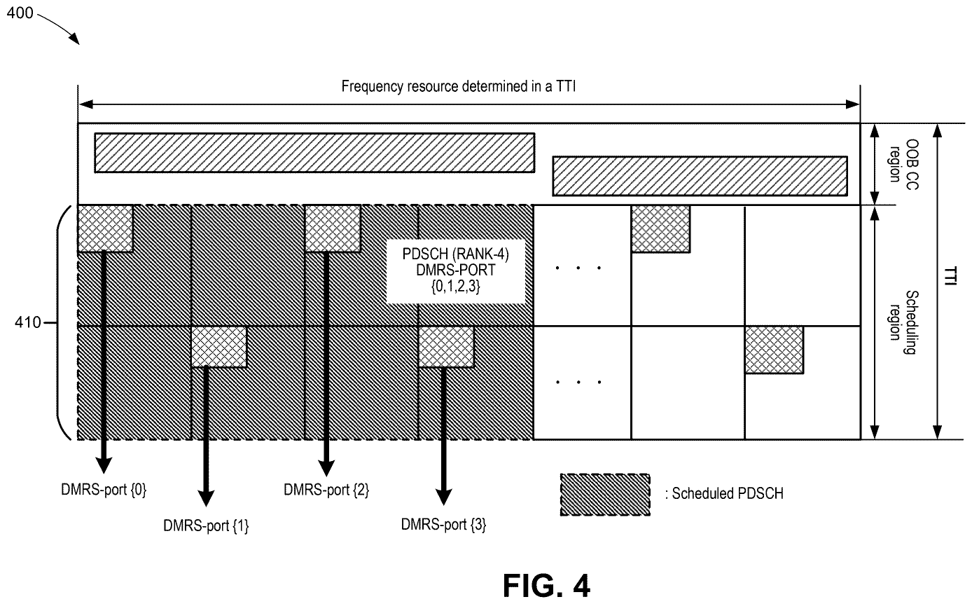

FIG. 4 shows an example of a time/frequency resource grid 400 that depicts a DM-RS port association between an IB-CCE and an associated PDSCH 410.

When a transmission rank for an IB-CCE is smaller than a transmission rank for the associated PDSCH, the DM-RS port for an IB-CCE may have the following association with the DM-RS ports for the associated PDSCH. In an example, the transmission rank for one or more IB-CCEs may be fixed and/or predetermined to be one (e.g., Rank=1) and the transmission rank for the associated PDSCH may be indicated via a scheduling DCI. A WTRU may receive the scheduling DCI before detection of the IB-CCE. By using the DM-RS port association, channel estimation performance may be further increased by aggregating DMRS resources between the IB-CCE and the associated PDSCH. One or more of the following approaches may apply.

The scheduling DCI may provide a subset of scheduling information for the PDSCH (e.g., transmission rank, set of DSUs, IB-CCE-related configuration, etc.) and the remainder of the scheduling information may be provided in the DCI carried by the IB-CCE (e.g., IB-DCI).

A DMRS port for an IB-CCE and DM-RS ports for the associated PDSCH may have one or more of the following association modes.

In a first association mode, a DM-RS port for an IB-CCE may be determined to be the lowest DM-RS port number among the DM-RS ports used for the associated data transmission. For example, if DMRS ports {1, 2, 3, 4} are used for Rank=4 transmission of the PDSCH, the DMRS port {1} may be used for the one or more IB-CCEs associated with the PDSCH.

In a second association mode, a DM-RS port for an IB-CCE may be determined based on the IB-CCE index and DM-RS ports determined for the associated PDSCH. For example, if DMRS ports {1, 2, 3, 4} are used for Rank=4 transmission of the PDSCH, the DM-RS port for the first IB-CCE may be the first DM-RS port of the PDSCH (e.g., DMRS port {1}); the DM-RS port for the second IB-CCE may be the second DM-RS port of the PDSCH (e.g., DMRS port {2}); and so forth. The DM-RS ports of the PDSCH may be cyclically mapped to one or more IB-CCES.

In a third association mode, the associated DM-RS port of a PDSCH for the DM-RS port of an IB-CCE may be indicated in a DCI (e.g., OOB-DCI) or configured via a higher layer signaling.

An association mode may be configured via a higher layer signaling or indicated in a DCI (e.g., OOB-DCI).

Whether a DMRS port of an IB-CCE has an association with the associated PDSCH may be determined based on one or more of the following techniques. The WTRU may be configured by a network to indicate whether there is a DM-RS port association between an IB-CCE and the associated PDSCH. A transmission rank of the PDSCH may be compared to a threshold (e.g., to determine whether the transmission rank of the PDSCH is higher than the threshold). For example, if the transmission rank of the PDSCH is higher than four (where four serves as the threshold in this example), a WTRU may conclude that there is no DM-RS port association between the IB-CCE and the PDSCH (e.g., high geometry). Finally, in some examples, an IB-CCE resource configuration (e.g., distributed allocation or localized allocation) may be used to determine whether a DMRS port of an IB-CCE has an association with the associated PDSCH.

One or more PDSCH candidates may be configured, defined, and/or determined within a TTI, wherein a PDSCH candidate may include one or more DSUs and one or more IB-CCEs within a PDSCH candidate resource. The WTRU may blindly decode or attempt to decode one or more PDSCH candidates to receive a scheduled PDSCH if the WTRU is scheduled in the TTI. One or more of the following possible aspects may apply.

Each PDSCH candidate may be associated with a respective DSU aggregation level (e.g., number of DSUs associated with the PDSCH candidate). A PDSCH candidate associated with a larger DSU aggregation level may have a larger number of PDSCH resources (e.g., than a PDSCH candidate associated with a smaller DSU aggregation level).

The WTRU may receive an indication (e.g., via OOB-CC) that a PDSCH is scheduled in one or more of PDSCH candidates in the TTI. The indication may include one or more of (i) PDSCH candidate configurations (e.g., number of PDSCH candidates, DSU aggregation levels, DM-RS configuration, etc.), (ii) a subset of PDSCH candidates the WTRU may be instructed to monitor, and/or (iii) a transport block size, which may determine a subset of PDSCH candidates for the WTRU to monitor.

A number of PDSCH candidates to monitor (e.g., a maximum number of PDSCH candidates to monitor) within a time window may be used. For example, within a TTI, a WTRU may monitor up to a particular number of PDSCH candidates (e.g., wherein the particular number of PDSCH candidates for the WTRU to monitor may be denoted by N_max or some other name). When a WTRU is to monitor OOB-CCEs and IB-CCEs within a TTI, each CCE type may have an associated maximum number of PDSCH candidates to monitor, respectively, or blind decoding number), respectively. The associated maximum number for a CCE type may indicate, for example, a maximum number of PDSCH candidates to be decoded blindly within a time window.

A WTRU may report the number (e.g., maximum number) of elements that the WTRU is capable of blindly decoding for OOB-CCEs and IB-CCEs within a TTI.

When a WTRU receives a DCI targeted for (e.g., intended for) the WTRU in an IB-CCE, the WTRU may determine that the associated PDSCH for the IB-CCE is scheduled for the WTRU.

The DCI may include a target WTRU identity (e.g., WTRU or WTRU-group specific RNTI, or a portion of a WTRU or WTRU-group-specific RNTI).

The DM-RS of the IB-CCE may be WTRU-specific (e.g., a DM-RS sequence may be scrambled with a WTRU-identity).

A WTRU may receive an indication of and/or be or provided with a subset of PDSCH candidates for the WTRU to monitor and/or attempt to decode from an associated DCI (e.g., a first DCI received from the associated OOB-CC), wherein the subset of PDSCH candidates may include a single PDSCH candidate. When the associated DCI indicates a single PDSCH candidate, the WTRU may conclude that the PDSCH candidate is scheduled for the WTRU.

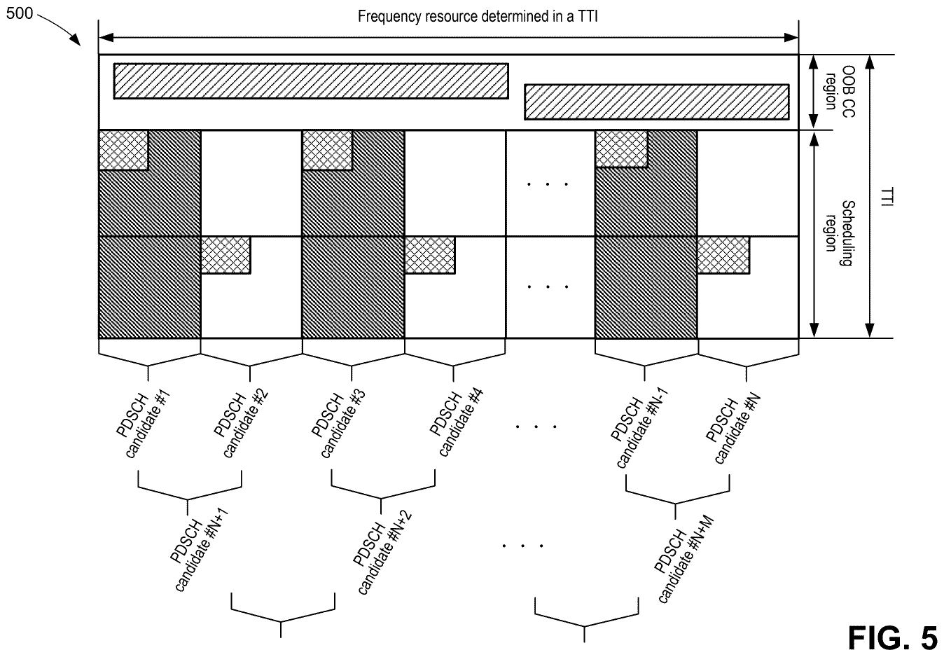

FIG. 5 shows an example of a time/frequency resource grid 500 that depicts a PDSCH candidates in a TTI.

A PDSCH candidate may include one or more PDSCH candidates which may have a smaller number of DSUs. For example, as shown in FIG. 5, the PDSCH candidate #N+2 may include the PDSCH candidate #1 and the PDSCH candidate #2. Thus, in some examples, multiple PDSCH candidates, each having a respective number of DSUs, may collectively be included in a single PDSCH candidate such that the number of DSUs in the single PDSCH candidate may be the sum of the respective numbers of DSUs for the multiple PDSCH candidates.

A WTRU may combine IB-CCEs within a PDSCH candidate for higher reliability. In addition or alternatively, a WTRU may aggregate one or more IB-CCEs within the PDSCH candidates.

A WTRU may monitor a first PDSCH candidate that has a higher number DSUs (e.g., than at least one other PDSCH candidate). In some examples, the WTRU may determine to remove some of a group of second PDSCH candidates. Those PDSCH candidates may overlap with the first PDSCH candidate as, in some examples, the WTRU hay have already decoded IB-CCEs within the group of second PDSCH candidates.

A WTRU may receive scheduling information that indicates one or more PDSCH candidates scheduled for the WTRU. Each respective one of the one or more scheduled PDSCH candidates may be associated with a respective set of link-adaptation parameters and/or scheduling parameters to demodulate the respective PDSCH. For instance, in the example shown in FIG. 5, a WTRU may blindly decode PDSCH candidates and determine that the PDSCH candidate #1 and the PDSCH candidate #4 are scheduled for the WTRU in the TTI. The scheduling parameters (e.g., modulation order, DM-RS configuration, transmission rank) for the first PDSCH candidate may be received from an IB-CCE associated with the first PDSCH candidate (e.g., an IB-CCE within the first PDSCH candidate resource). The scheduling parameters for the second PDSCH candidate may be received from an IB-CCE associated with the second PDSCH candidate (e.g., an IB-CCE within the second PDSCH candidate). The scheduling parameters for the first PDSCH and the scheduling parameters for the second PDSCH may be different. For example, the PDSCH in the PDSCH candidate #1 may be transmitted with Rank=1 and the PDSCH in the PDSCH candidate #2 may be transmitted with Rank=2.

A payload may be distributed over the one or more PDSCH candidates.

The WTRU may determine the subset of PDSCH candidates to monitor based on WTRU capability (e.g., WTRU bandwidth capability). For example, a WTRU with wideband reception capability may monitor PDSCH candidates with different numbers of DSU aggregation levels. On the other hand, a WTRU with narrowband reception capability may monitor the PDSCH candidates which have resources within the WTRU's supported frequency band.

The second type of control channel may be transmitted, monitored, and/or received outside of scheduled time/frequency resources for data transmission and/or reception (e.g., PDSCH, PUSCH, PSSCH). The second type of control channel may be referred to as an out-of-band control channel (OOB-CC). In some examples, the OOB-CC may be referred to interchangeably as the global control channel, the first-stage control channel, the WTRU common control channel, the WTRU-group common control channel, and the device-type agnostic control channel.

An OOB-CC may be configured with time/frequency resources (e.g., a number of subcarriers and/or a number of OFDM symbols) within a TTI and/or an associated periodicity at which the OOB-CC is to be monitored by a WTRU. The time/frequency resource configured for an OOB-CC may not, in some examples, overlap with time/frequency resources used for a data transmission (e.g., a scheduling resource for a PDSCH).

One or more OOB-CC types may be used. A first OOB-CC type may be based on a coherent detection (e.g., modulated data symbols and an associated DM-RS) and a second OOB-CC type may be based on a non-coherent detection (e.g., sequence-based transmission). In the first OOB-CC type (e.g., referred hereafter as “Type-1 OOB-CC”), the modulated data symbols may carry control information (e.g., DCI) and/or may be demodulated with an estimated channel from the associated DM-RS.

In the second OOB-CC type (e.g., referred hereafter as “Type-2 OOB-CC”), a sequence among a set of sequences may be transmitted and received by a WTRU. Furthermore, the WTRU may determine control information associated with the sequence. In particular, the set of sequences may be pre-configured and the sequence may be transmitted in a configured time/frequency resource. The sequence may carry a certain number of bits (e.g., X bits, where X denotes a non-negative integer). If a network wants to transmit control information that carries more than X bits, the network may transmit multiple sequences in a row so that a WTRU may receive the control information that carries more than the X bits. For example, if the control information is (T×X) bits (where T and X represent non-negative integers), T sequences may be transmitted in configured resources (e.g., T OFDM symbols within a slot).

The WTRU may determine an OOB-CC type based on a payload size of a control channel. For example, if the payload size of the control information is larger than a threshold, a Type-1 OOB-CC may be used. Otherwise, a Type-2 OOB-CC may be used.

For a given payload of control information, if both a Type-1 OOB-CC and a Type-2 OOB-CC can carry the control information, a Type-2 OOB-CC may provide better coverage and detection performance, while a Type 1 OOB-CC may be more flexible and may be able to carry a payload of a larger size.

The WTRU may determine an OOB-CC type based on control information types. A control information type may be determined based on one or more of the following possible factors. For example, the WTRU may determine the OOB-CC type based on whether the control information targets a WTRU or a group of WTRUs. In an example, a Type-1 OOB-CC may be used for control information that targets a WTRU (e.g., scheduling DCI for PDSCH, PUSCH, and/or PSSCH, DCI triggering measurement reporting, etc.). In this example, a Type-2 OOB-CC may be used for control information that targets a group of WTRUs (e.g., wake-up signal, paging early indication, SIB scheduling, etc.).

The WTRU may determine the OOB-CC type based on whether the control information is associated with scheduling data. For example, a Type-1 OOB-CC may be used when the control information includes scheduling information for data (e.g., PDSCH, PUSCH, PSSCH). In this example, a Type-2 OOB-CC may be used when the control information does not include scheduling information (e.g., wake-up signal, PDCCH skipping indication, PDCCH search space group switching indication, paging early indication, bandwidth part switching, etc.).

The WTRU may determine the OOB-CC type based on whether the control information activates and/or deactivates configured WTRU behavior. For example, a Type-2 OOB-CC may be used to activate and/or deactivate a configured uplink grant. In this example, a Type-1 OOB CC may be used for a dynamic uplink grant.

The WTRU may determine the OOB-CC type based on at least one of a WTRU-sided condition, a NW-sided condition, and/or a spectrum-related condition. For example, a Type-1 OOB-CC type may be used for a WTRU that has a first WTRU capability (e.g., such as the capability to receive a wideband signal). In this example, a Type-2 OOB-CC type be used for a WTRU that has a second WTRU capability (e.g., such as a bandwidth-limited WTRU).

The WTRU may be configured (e.g., via a higher layer signaling) with a set of downlink resources (e.g., a set of PDSCH candidates) with a periodicity (e.g., including every TTI). The downlink resources may comprise a PDSCH resource semi-statically configured for the WTRU. Each downlink resource (e.g., PDSCH candidate) may be monitored by a WTRU when the downlink resource configuration is activated; the WTRU may stop monitoring such a downlink resource when the downlink resource configuration is deactivated. A downlink resource that is semi-statically configured may be referred to as a semi-persistent scheduling (SPS) resource. Such an SPS resource may, in some examples, be interchangeably referred to as an SPS candidate resource, an SPS candidate, and/or a PDSCH candidate. One or more of the following approaches may apply.

An activation and/or deactivation may be based on an RRC configuration, a MAC-CE indication, and/or L1-signaling (e.g., DCI, sequence, etc.). In this approach, if L1-signaling is used to activate monitoring of the SPS candidate resources by the WTRU, the L1-signaling may comprise control information transmitted and/or received from an associated OOB-CC (e.g., a Type-1 OOBC and/or a Type-2 OOBC).

An activated SPS candidate resource may include an IB-CC. In this approach, the IB-CC may provide one or more scheduling parameters for a PDSCH scheduled in the SPS candidate resource. The one or more scheduling parameters may include at least one of an MCS, a transmission rank, a HARQ process number, a DM-RS configuration, a TCI state, and/or a Quasi Co-Location (QCL) association.

An activated SPS candidate resource may or may not be scheduled for a WTRU. The WTRU may have to check an associated IB-CC for the activated SPS candidate resource to determine whether the SPS candidate resource is scheduled for the WTRU or not.

The associated IB-CC may include a WTRU-identity (e.g., a full WTRU-specific RNTI, a portion of a WTRU-specific RNTI, a WTRU-group-specific RNTI, a C-RNTI, an IMSI, a TMSI, an s-TMSI, etc.). The WTRU-identity may indicate the WTRU for which the SPS candidate resource is scheduled.

A DMRS of the associated IB-CC may be scrambled with a WTRU-identity. The WTRU may detect the WTRU-identity from the DMRS. and receive the SPS candidate resource upon detecting the corresponding WTRU-identity.

The WTRU may report a HARQ-NACK associated with an SPS candidate resource in instances where the WTRU has received an IB-CC that targets the WTRU, but has failed to decode the scheduled PDSCH.

The WTRU may determine that the WTRU is not scheduled in an SPS candidate resource if the WTRU does not detect control information that targets the WTRU in an associated IB-CC.

More than one SPS candidate resource may be configured (e.g., indicated to a WTRU via configuration information) and activated and/or deactivated. When multiple SPS candidate resources are configured and/or activated, a single SPS candidate resource may be scheduled at a time. If a WTRU detects a scheduled SPS candidate resource, the WTRU may skip (e.g., refrain from) decoding the remainder (e.g., rest) of the SPS candidate resources in a TTI.

The WTRU may receive configuration information that indicates one or more PDSCH candidates' configurations and/or an associated IB-CC from an associated OOB-CC. The WTRU may attempt to decode and/or receive one or more PDSCH candidates based on the latest configuration information that was received from the associated OOB-CC. The configuration information may include a number of PDSCH candidates.

The configuration information may include a respective resource size of each PDSCH candidate.

The configuration information may include a respective size of an IB-CC within each PDSCH candidate.

The configuration information may include an aggregation-level set of IB-CCEs for a PDSCH candidate with multiple DSUs.

The configuration information may include a DMRS-port association between an IB-CCE and a PDSCH.

The configuration information may include contents of an IB-CC (e.g., a DCI format carried in an IB-CC or an indication of which bit field in the DCI is activated and/or deactivated)

A WTRU may further receive configuration information that comprises with one or more PDSCH candidate resource configurations. Each candidate resource configuration may include a set of PDSCH candidates within a TTI and a periodicity (e.g., number of TTIs) of the PDSCH candidates in the set of PDSCH candidates. Each candidate resource configuration may be associated with an index (e.g., a configuration number). An associated OOB-CC (e.g., a DCI carried in the OOB-CC) may indicate which PDSCH candidate resource configuration is activated or deactivated.

A first type of WTRU (e.g., a WTRU with wideband capability) may receive PDSCH-scheduling information directly from an OOB-CC (e.g., the scheduling information may indicate a PDSCH candidate scheduled for the WTRU and associated scheduling parameters). In this case, a second DCI is not needed for PDSCH reception. The WTRU may receive a scheduled PDSCH in an IB-CC resource that is configured for a set of PDSCH candidates in cases where the IB-CC resources overlap with the scheduled PDSCH. A second type of WTRU (e.g., a WTRU with narrowband capability) may receive PDSCH-candidate-configuration information (or activation of configured PDSCH candidates) from an associated OOB-CC. This second type of WTRU may monitor PDSCH candidates (e.g., attempt to decode associated IB-CCs) to receive a PDSCH.

When a WTRU of the first type would benefit from a coverage enhancement (e.g., the WTRU falls under a certain coverage mode), the WTRU may start to use a PDSCH candidate and/or an IB-CC for a PDSCH reception.

A DCI for uplink scheduling may be transmitted and/or received in an OOB-CC. In this implementation, a DCI for downlink scheduling may be transmitted and/or received in an IB-CC.

1. A wireless transmit/receive unit (WTRU) comprising:
a processor configured to:
receive first downlink control information in an out-of-band control channel (OOB-CC), wherein the first downlink control information comprises configuration information associated with a plurality of physical downlink shared channel candidates of a scheduling region, wherein the scheduling region is associated with data transmissions;
decode one or more in-band control channel elements (IB-CCEs) associated with a subset of the plurality of physical downlink shared channel candidates to receive second downlink control information associated with the WTRU, wherein the second downlink control information indicates a scheduled data transmission for the WTRU in the subset of the plurality of physical downlink shared channel candidates; and
demodulate the scheduled data transmission in the subset of the plurality of physical downlink shared channel candidates using scheduling parameters indicated by the second downlink control information provided by the one or more IB-CCEs.

2. The WTRU of claim 1, wherein the configuration information of the first downlink control information comprises an indication of a size of the subset of the plurality of physical downlink shared channel candidates, an indication of a size of the one or more IB-CCEs, an aggregation level associated with the one or more IB-CCEs, or an indication of an association between reference signal ports and the one or more IB-CCEs.

3. The WTRU of claim 1, wherein the second downlink control information comprises an indication of the scheduling parameters for demodulating the scheduled data transmission, and wherein the scheduling parameters comprises a modulation and coding scheme (MCS), a transmission rank, a transmission configuration indication (TCI) state, a reference signal configuration, or a hybrid automatic repeat request (HARQ) process number associated with the scheduled transmission.

4. The WTRU of claim 1, wherein the first downlink control information is received outside of the scheduling region associated with the data transmissions, and wherein the second downlink control information is received within the scheduling region associated with the data transmissions.

5. The WTRU of claim 1, wherein the processor is further configured to:
determine the subset of the plurality of physical downlink shared channel candidates based on one or more of a capability of the WTRU, an identity of the WTRU, or an indication provided via the first downlink control information of the OOB-CC.

6. The WTRU of claim 1, wherein the scheduling region comprises a plurality of data channel units and a plurality of data scheduling units, wherein each data scheduling unit comprises one or more data channel units, and wherein a data channel unit is a minimum schedule resource for a data transmission.

7. The WTRU of claim 1, wherein the processor is further configured to:
decode at least one IB-CCE associated with each physical downlink shared channel candidate of the plurality of physical downlink shared channel candidates to identify the second downlink control information associated with the WTRU.

8. The WTRU of claim 1, wherein a physical downlink shared channel candidate of the subset of the plurality of physical downlink shared channel candidates comprises a plurality of IB-CCEs.

9. The WTRU of claim 8, wherein a subset of the plurality of IB-CCEs comprises the second downlink control information associated with the WTRU, and a remainder of the plurality of IB-CCEs are reallocated for the scheduled data transmission.

10. The WTRU of claim 1, wherein the one or more IB-CCEs are located within the subset of the plurality of physical downlink shared channel candidates, and wherein the subset of the plurality of physical downlink shared channel candidates are assigned to the WTRU.

11. The WTRU of claim 1, wherein a remainder of the plurality of physical downlink shared channel candidates is associated with one or more other WTRUs.

12. A method performed by a wireless transmit/receive unit (WTRU), the method comprising:
receiving first downlink control information in an out-of-band control channel (OOB-CC), wherein the first downlink control information comprises configuration information associated with a plurality of physical downlink shared channel candidates of a scheduling region, wherein the scheduling region is associated with data transmissions;
decoding one or more in-band control channel elements (IB-CCEs) associated with a subset of the plurality of physical downlink shared channel candidates to receive second downlink control information associated with the WTRU, wherein the second downlink control information indicates a scheduled data transmission for the WTRU in the subset of the plurality of physical downlink shared channel candidates; and
demodulating the scheduled data transmission in the subset of the plurality of physical downlink shared channel candidates using scheduling parameters indicated by the second downlink control information provided by the one or more IB-CCEs.

13. The method of claim 12, wherein the configuration information of the first downlink control information comprises an indication of a size of the subset of the plurality of physical downlink shared channel candidates, an indication of a size of the one or more IB-CCEs, an aggregation level associated with the one or more IB-CCEs, or an indication of an association between reference signal ports and the one or more IB-CCEs.

14. The method of claim 12, wherein the second downlink control information comprises an indication of the scheduling parameters for demodulating the scheduled data transmission, and wherein the scheduling parameters comprises a modulation and coding scheme (MCS), a transmission rank, a transmission configuration indication (TCI) state, a reference signal configuration, or a hybrid automatic repeat request (HARQ) process number associated with the scheduled transmission.

15. The method of claim 12, wherein the first downlink control information is received outside of the scheduling region associated with the data transmissions, and wherein the second downlink control information is received within the scheduling region associated with the data transmissions.

16. The method of claim 12, further comprising:
determining the subset of the plurality of physical downlink shared channel candidates based on one or more of a capability of the WTRU, an identity of the WTRU, or an indication provided via the first downlink control information of the OOB-CC.

17. The method of claim 12, wherein the scheduling region comprises a plurality of data channel units and a plurality of data scheduling units, wherein each data scheduling unit comprises one or more data channel units, and wherein a data channel unit is a minimum schedule resource for a data transmission.

18. The method of claim 12, further comprising:
decoding at least one IB-CCE associated with each physical downlink shared channel candidate of the plurality of physical downlink shared channel candidates to identify the second downlink control information associated with the WTRU.

19. The method of claim 1, wherein a physical downlink shared channel candidate of the subset of the plurality of physical downlink shared channel candidates comprises a plurality of IB-CCEs.

20. The method of claim 19, wherein a subset of the plurality of IB-CCEs comprises the second downlink control information associated with the WTRU, and a remainder of the plurality of IB-CCEs are reallocated for the scheduled data transmission.
